(19) United States
(12) Patent Application Publication
(10) Pub. No.: US 2026/0176184 A1
(43) Pub. Date: Jun. 25, 2026

(54) METHOD FOR PRODUCING AN OPTICAL FIBER PREFORM

(71) Applicant: Heraeus Quarzglas GmbH & Co. KG, Hanau (DE)

(72) Inventors: Konstantin KRICK, Kleinostheim (DE); Eric RUDZINSKI, Hanau (DE); Karsten BRÄUER, Hanau (DE); Sascha PIHAN, Kleinostheim (DE)

(21) Appl. No.: 19/417,511

(22) Filed: Dec. 12, 2025

(30) Foreign Application Priority Data
Dec. 19, 2024 (EP) 24221554.9

(51) Int. Cl. C03B 37/018

(52) U.S. Cl. CPC C03B 37/01884; C03B 37/01861

(57) ABSTRACT

A method for producing an optical fiber preform, comprising the method steps of synthesizing glass particles using a plasma zone generated by a plasma generator; repeatedly moving a glass preform axially forward and backward relative to the plasma generator during a rotational movement of the glass preform, wherein the forward and backward movement takes place between two reversal points at a relative feed rate; and, depositing the glass particles on the glass preform while the glass preform moves and rotates relative to the plasma generator.

### CROSS-REFERENCE TO RELATED APPLICATION

This application claims priority pursuant to 35 U.S.C. 119(a) to European Patent Application No. 24221554.9, filed Dec. 19, 2024, which application is incorporated herein by reference in its entirety.

### FIELD OF THE INVENTION

The invention relates to a method for producing an optical fiber preform, comprising the method steps of:
a. synthesizing glass particles using a plasma zone generated by a plasma generator;
b. repeatedly moving a glass preform axially forward and backward relative to the plasma generator during a rotational movement of the glass preform, wherein the forward and backward movement takes place between two reversal points at a relative feed rate;
c. depositing the glass particles on the glass preform while the glass preform moves and rotates relative to the plasma generator; wherein:
   (i) the relative feed rate of the plasma generator with respect to the glass preform has a value of V_{Mitte} at a center of the glass preform;
   (ii) the relative feed rate of the plasma generator with respect to the glass preform is reduced from V_{Mitte} to a value of Vₕᵢₙ if the plasma generator moves relatively from the center of the glass preform toward one of the reversal points; and,
   (iii) the relative feed rate of the plasma generator with respect to the glass preform is reduced from a value of V_{rück} to V_{Mitte} if the plasma generator moves relatively from one of the reversal points toward the center of the glass preform.

### BACKGROUND

Preforms for the production of an optical fiber are often generated by means of a plasma generator, such as a plasma torch. Such a plasma generator in the form of a plasma torch can, for example, be called a high-frequency induction plasma torch: This is a plasma torch which is equipped with a high-frequency coil on the edge of a gas flow tube. A high-frequency current is applied to ionize the gas contained therein and to emit the resulting plasma from a nozzle. The plasma generator can also be a plasma torch that is operated using a different technology, for example by means of microwave radiation. The plasma generator can also be a device that generates a plasma by means of induction. Such a plasma generator preferably comprises an induction coil, which generates the plasma.

The plasma generated in this way is used to synthesize glass particles, which are deposited by deposition on a glass preform, such as a glass rod a glass tube. For this purpose, glass precursors, such as silicon tetrachloride, optional dopants, such as sulfur hexafluoride, as well as oxygen and any auxiliary gases, such as nitrogen or argon, are continuously fed to the plasma and the glass particles synthesized in this way are deposited onto a surface of a glass preform, such as a glass rod or a glass tube, which moves forward and backward relative to the plasma generator while rotating.

The deposition of the synthesized glass particles is in particular challenging at the edges of the glass preform since these edges are subjected to a double pass by the plasma generator within a very short period of time, once on the forward path and directly thereafter again on the backward path, which therefore subjects these areas to particularly high thermal stress. At the same time, the edges also experience particularly strong cooling if the plasma generator is located in the region of the opposite edge of the glass preform. In other words, the edges cool down particularly strongly between two passes (when passing over the opposite edge) and also heat up particularly strongly (when passing over the corresponding edge twice). In particular, the directly consecutive double pass, and the associated particularly strong heating of the corresponding edge, leads to a partial evaporation of the synthesized glass particles deposited on the corresponding edge. This leads to an uneven material structure of the edges in comparison to the central regions of the glass preform, which are subject to less thermal stress in comparison. Any doping of the synthesized glass particles at the edges is also negatively affected by the thermal stress, which is why the edges have a lower doping than the central regions of the glass preform, as described, for example, in European patent application EP 1 997 783 A2. The lower doping may be the result of thermally induced out-diffusion. The high thermal stress of the edges of the glass preform thus results in high production waste since the edges of the glass preform are not suitable for further processing to produce an optical fiber.

In principle, there are multiple methods for depositing the synthesized glass particles on a glass preform: (1) The particles are first deposited in the form of a porous layer, the porosity of which is subsequently eliminated in a special thermal process by melting. This step leads to densification of the initially porous structure to form homogeneous glass. (2) Alternatively, the deposition is carried out directly as a compact glass layer, thereby eliminating the subsequent densification step.

The difficulties described above, in particular the thermal stress at the edges of the glass preform, pose a challenge in all these methods.

There is therefore demand in the market for an improved method for producing an optical fiber preform.

### SUMMARY

One object of the present invention is to overcome, at least in part, one or more of the disadvantages resulting from the prior art.

In particular, it is an object of the invention to provide a method for producing an optical fiber preform that has the lowest possible production waste. Furthermore, the method should provide a preform with the most uniform doping possible. The method according to the invention should be as simple as possible to implement. Furthermore, it should be as cost-effective as possible.

### PREFERRED EMBODIMENTS OF THE INVENTION

A contribution to the at least partial fulfillment of at least one of the aforementioned objects is made by the features of the independent claims. The dependent claims provide preferred embodiments that contribute to the at least partial fulfillment of at least one of the objects.

A first embodiment of the invention is a method for producing an optical fiber preform, comprising the method steps of:
a. synthesizing glass particles using a plasma zone generated by a plasma generator;
b. repeatedly moving a glass preform axially forward and backward relative to the plasma generator during a rotational movement of the glass preform, wherein the forward and backward movement takes place between two reversal points at a relative feed rate;
c. depositing the glass particles on the glass preform while the glass preform moves and rotates relative to the plasma generator; wherein
   (i) the relative feed rate of the plasma generator with respect to the glass preform has a value of V_{Mitte} at a center of the glass preform;
   (ii) the relative feed rate of the plasma generator with respect to the glass preform is reduced from V_{Mitte} to a value of Vₕᵢₙ if the plasma generator moves relatively from the center of the glass preform toward one of the reversal points; and,
   (iii) the relative feed rate of the plasma generator with respect to the glass preform is reduced from a value of V_{rück} to V_{Mitte} if the plasma generator moves relatively from one of the reversal points toward the center of the glass preform.

In a preferred embodiment of the method, V_{rück}>V_{Mitte}>Vₕᵢₙ or, in other words, V_{rück} has a greater value than V_{Mitte} and V_{Mitte} has a greater value than Vₕᵢₙ. This embodiment is a second embodiment of the method, which is preferably dependent on the first embodiment of the invention.

In a preferred embodiment of the method, a difference in values between V_{Mitte} and Vₕᵢₙ substantially corresponds to a difference in values between V_{rück} and V_{Mitte}. This embodiment is a third embodiment of the invention, which is preferably dependent on the first or second embodiment of the invention.

In a preferred embodiment of the method, the reductions in relative feed rates from V_{Mitte} to Vₕᵢₙ and from V_{rück} to V_{Mitte} have a substantially exponential or parabolic profile. This embodiment is a fourth embodiment of the invention, which is preferably dependent on one of the preceding embodiments of the invention.

In a preferred embodiment of the method, the glass particles synthesized in method step a. contain a dopant. This embodiment is a fifth embodiment of the invention, which is preferably dependent on one of the preceding embodiments of the invention.

In a preferred embodiment of the method, V_{Mitte} has a value in the range between 500 mm/min and 3000 mm/min. This embodiment is a sixth embodiment of the invention, which is preferably dependent on one of the preceding embodiments of the invention.

In a preferred embodiment of the method, Vₕᵢₙ has a value in the range between 0.4 times and 0.9 times V_{Mitte}. This embodiment is a seventh embodiment of the invention, which is preferably dependent on one of the preceding embodiments of the invention.

In a preferred embodiment of the method, V_{rück} has a value in the range between 1.1 times and 1.6 times V_{Mitte}. This embodiment is an eighth embodiment of the invention, which is preferably dependent on one of the preceding embodiments of the invention.

In a preferred embodiment of the method, an average dwell time of the plasma generator at each axial position of the glass preform is substantially the same.

This embodiment is a ninth embodiment of the invention, which is preferably dependent on one of the preceding embodiments of the invention.

In a preferred embodiment of the method, the relative feed rate has the value V_{Mitte} over an axial extent of the glass preform which corresponds to 0% to 50%, preferably 15% to 45%, of a total axial length of the glass preform. This embodiment is a tenth embodiment of the invention, which is preferably dependent on one of the preceding embodiments of the invention.

A preferred embodiment of the method comprises:
(i) a plasma power in the center of the glass preform has a value of P_{Mitte};
(ii) the plasma power is increased from P_{Mitte} to a value of Pₕᵢₙ if the plasma generator moves relatively from the center of the glass preform toward one of the reversal points; and,
(iii) the plasma power is increased from a value P_{rück} to P_{Mitte} if the plasma generator moves relatively from one of the reversal points toward the center of the glass preform.

This embodiment is an eleventh embodiment of the invention, which is preferably dependent on one of the preceding embodiments of the invention.

In a preferred embodiment of the method, the plasma power is increased when the relative feed rate is reduced. This embodiment is a twelfth embodiment of the invention, which is preferably dependent on the eleventh embodiment of the invention.

In a preferred embodiment of the method, the glass preform in the course of the method has a temperature between a minimum temperature T_{Min} and a maximum temperature T_{Max}, wherein the temperature difference T_{Diff} between T_{Min} and T_{Max} is at most 200 K. This embodiment is a thirteenth embodiment of the invention, which is preferably dependent on one of the preceding embodiments of the invention.

In a preferred embodiment of the method, T_{Max} at most takes a value of 2650° C. This embodiment is a fourteenth embodiment of the invention, which is preferably dependent on the thirteenth embodiment of the invention.

In a preferred embodiment of the method, the glass preform is a glass rod, the plasma generator is a plasma torch, and the plasma zone is a plasma flame.

This embodiment is a fifteenth embodiment of the invention, which is preferably dependent on one of the preceding embodiments of the invention.

### General

In one embodiment, if an element is denoted by the singular, an embodiment is also contemplated in which more than one such element is present. The use of a term for an element in the plural in principle also encompasses an embodiment in which only a single corresponding element is included.

Unless otherwise indicated or clearly excluded from the context, it is possible in principle, and is hereby clearly contemplated, that features of different embodiments may also be present in the other embodiments described herein. Likewise, it is contemplated in principle that all features described herein in connection with a method are also applicable to the products and devices described herein, and vice versa. All such considered combinations are not explicitly listed in all instances, simply in order to keep the description brief. Technical solutions known to be equivalent to the features described herein are also intended in principle to be encompassed by the scope of the invention.

In the present description, specifications of ranges also include the values specified as limits. A specification of the type “in the range from X to Y” with respect to a variable A consequently means that A can take the values X, Y and values between X and Y. Ranges limited on one side of the type “up to Y” for a variable A accordingly mean values of Y and less than Y. Some of the features described are associated with the term “substantially.” The term “substantially” is to be understood in such a way that, under real conditions and manufacturing techniques, a mathematically exact interpretation of terms such as “superimposition,” “perpendicular,” “diameter” or “parallelism” can never be given exactly, but only within certain manufacturing error tolerances. For example, “substantially perpendicular axes” enclose an angle of 85 degrees to 95 degrees between them, and “substantially equal volumes” comprise a deviation of up to 5% by volume. For example, a “device consisting substantially of plastics” comprises a plastics content of ≥95 to ≤100% by weight. For example, a “substantially complete filling of a volume B” comprises a filling of ≥95 to ≤100% by volume of the total volume of B.

When an indefinite or definite article is used when referring to a singular noun, such as “a,” “an” or “the,” it includes a plural of that noun unless explicitly stated otherwise. When the term “comprising” is used in the present description and claims, other elements are not thereby excluded.

For the purposes of the present invention, the terms “consisting substantially of” and “consisting of” are considered embodiments of the term “comprising”. When a group is defined below as comprising at least a certain number of embodiments, this is also to be understood as disclosing a group which, in one embodiment, consists substantially only of these embodiments or, in one embodiment, consists only of these embodiments.

Terms such as “obtainable” or “definable” and “obtained” or “defined” are used interchangeably. This means, for example, that the term “obtained” does not imply that an embodiment must be obtained, for example, by the sequence of steps following the term “obtained”, unless the context clearly dictates otherwise, although such a limited understanding is always included in the terms “obtained” or “defined” as an embodiment. Whenever the terms “including” or “with” are used, these terms are synonymous with “comprising” as defined above.

### BRIEF DESCRIPTION OF THE DRAWINGS

The invention is further illustrated by way of example below by means of figures. The invention is not limited to the figures.

In the figures:

FIG. 1 shows a schematic exemplary arrangement for carrying out a method for producing an optical fiber preform;

FIG. 2 shows an exemplary variation of a relative feed rate of the method for producing an optical fiber preform;

FIG. 3 shows an exemplary temperature curve of a glass preform in the form of a glass rod during the method according to the invention in comparison to a temperature curve of a glass rod during a method with a constant relative feed rate; and,

FIG. 4 shows a deposition profile of a preform produced according to the method according to the invention in comparison to a deposition profile of a preform produced according to a method with a constant relative feed rate.

### DETAILED DESCRIPTION OF THE INVENTION

A first subject matter of the invention relates to a method for producing an optical fiber preform, comprising the method steps of:
a. synthesizing glass particles using a plasma zone generated by a plasma generator;
b. repeatedly moving a glass preform axially forward and backward relative to the plasma generator during a rotational movement of the glass preform, wherein the forward and backward movement takes place between two reversal points at a relative feed rate;
c. depositing the glass particles on the glass preform while the glass preform moves and rotates relative to the plasma generator; wherein,
   (i) the relative feed rate of the plasma generator with respect to the glass preform has a value of VMitte at a center of the glass preform;
   (ii) the relative feed rate of the plasma generator with respect to the glass preform is reduced from VMitte to a value of Vhin if the plasma generator moves relatively from the center of the glass preform toward one of the reversal points;
   (iii) the relative feed rate of the plasma generator with respect to the glass preform is reduced from a value of Vrück to VMitte if the plasma generator moves relatively from one of the reversal points toward the center of the glass preform.

In a method step a., glass particles are synthesized using a plasma zone generated by a plasma generator. The plasma generator can generate the plasma zone, for example, by means of an induction coil. In a preferred embodiment, the plasma generator is a plasma torch, which generates a plasma zone in the form of a plasma flame.

For generating the glass particles, glass precursors, such as silicon tetrachloride, are fed to the plasma zone, preferably constantly, together with oxygen, argon, and/or nitrogen, which are converted into glass particles in the plasma zone. Optionally, dopants can be added in order to adapt the refractive index of the glass particles to the application of the preform.

Preferably, sulfur hexafluoride is added to the plasma zone together with the remaining glass precursors in order to obtain fluorinated glass particles.

In a method step b., a glass preform, such as a glass rod or a glass tube, is repeatedly moved axially forward and backward relative to the plasma generator. Either the glass preform, the plasma generator, or the glass preform and the plasma generator can be moved. The forward and backward movement of the glass preform relative to the plasma generator takes place between two reversal points at which the relative movement changes direction, i.e., for example, a forward movement reverses into a backward movement. The relative movement takes place in the axial extent, i.e., along the longitudinal axis of the glass preform. The relative movement takes place at least over the entire length of the glass preform, preferably even beyond the edge regions of the glass preform, so that the plasma generator is positioned once at each axial position of the glass preform during each forward movement and each backward movement. In other words, the reversal points are arranged in such a way that the glass preform is arranged with its entire axial length between the two reversal points.

The synthesized glass particles can thus be deposited at each axial position of the glass preform during each of the relative movements (see method step c.).

Simultaneously with the relative movement, a rotational movement about the longitudinal axis or, in other words, a rotation of the glass preform takes place so that uniform deposition of the synthesized glass particles around the circumference of the glass preform is also possible (see method step c.).

The glass preform preferably comprises a quartz glass; preferably, the glass preform consists of a quartz glass. Depending on the field of application of the preform, the quartz glass of the glass preform may contain a dopant, such as fluorine. In a method step c., the glass particles synthesized in the plasma zone of the plasma generator are deposited onto the glass preform moving relative to the plasma generator and rotating.

In one embodiment, the glass preform is a glass tube and the plasma zone is generated within the glass tube, wherein the synthesized glass particles are deposited onto an inner surface of the glass tube. In this embodiment, the plasma generator preferably generates the plasma zone by means of induction, for which purpose the plasma generator preferably comprises an induction coil, which is preferably arranged in a sleeve-like manner around the glass tube. In this embodiment, the induction coil is moved relative to the glass tube, wherein the plasma zone generated in the glass tube by the induction coil moves together with the induction coil. In this embodiment, the deposition of the synthesized glass particles takes place on the inner surface of the glass tube.

In a further embodiment, the glass preform is a glass rod and the plasma zone is generated by a plasma flame of a plasma torch. In this embodiment, the plasma torch is moved relative to the glass rod while the plasma flame is expanded onto the glass rod, causing the synthesized glass particles to be deposited onto an outer surface of the glass rod.

In order to achieve the most uniform deposition of the glass particles on the glass preform, a relative feed rate, i.e., the speed at which the plasma generator and the glass preform move relative to each other, is adapted to an axial position of the plasma generator with respect to the longitudinal axis of the glass preform. The relative feed rate is thus not constant over the entire length of the glass preform but varies depending on the relative arrangement of the plasma generator and the glass preform.

In a center, in particular an axial center, of the glass preform, the relative feed rate has a value V_{Mitte}.

If the plasma generator moves relative to the glass preform from the center of the glass preform to one of the reversal points, the relative feed rate is reduced from the value V_{Mitte} to a value Vₕᵢₙ. The relative feed rate is thus decelerated if the plasma generator moves from the center of the glass preform toward one of the reversal points. The deceleration from V_{Mitte} to Vₕᵢₙ can start directly in the center of the glass preform. In further embodiments of the method, the deceleration from V_{Mitte} to Vₕᵢₙ does not start directly in the center of the glass preform, but only after the plasma torch has moved relative to the glass preform from the center of the glass preform over 5% to 40%, preferably over 10% to 35%, more preferably over 15% to 30%, of the total length of the glass preform in the direction of the corresponding reversal point.

Preferably, the relative feed rate decelerates from V_{Mitte} to Vₕᵢₙ continuously until the value Vₕᵢₙ is reached.

Provided that the deceleration of the relative feed rate from V_{Mitte} to Vₕᵢₙ has started, from the center of the glass preform in the direction of one of the reversal points, the plasma generator thus remains continuously longer above a particular axial position of the glass preform than would be the case with the relative feed rate V_{Mitte}. Preferably, the plasma generator remains above a particular axial position of the glass preform relative to the glass preform for the longest period of time when the relative feed rate has taken the value Vₕᵢₙ. The reduction of the relative feed rate from V_{Mitte} to Vₕᵢₙ has the result that a particular axial position of the glass preform is passed over slower the longer it has been since the last pass of the plasma generator at this position. This can at least partially compensate for the increased cooling of the corresponding position since the last pass, which can lead to more uniform thermal stress.

At the reversal point, which is preferably located spatially behind the corresponding end of the glass preform, a reversal of the relative movement then takes place, preferably immediately. A forward movement thus becomes a backward movement, or vice versa.

If the plasma generator moves relatively from one of the reversal points to the center of the glass preform, the relative feed rate is reduced from a value V_{rück} to the value V_{Mitte}. The relative feed rate is thus decelerated if the plasma generator moves from one end of the glass preform toward the center of the glass preform.

Preferably, the relative feed rate decelerates from V_{rück} to V_{Mitte} continuously until the value V_{Mitte} is reached. Preferably, during a relative movement in the direction of the center of the glass preform, the relative feed rate thus has the highest value of the relative feed rate, preferably the value V_{rück}, at the corresponding end of the glass preform, wherein this value is reduced, preferably continuously, until the value V_{Mitte} is reached. The value V_{Mitte} can only be reached directly at the center of the glass preform. In further embodiments, the value V_{Mitte} is reached if the plasma generator is still 5% to 45%, preferably 10% to 40%, more preferably 15% to 35%, of the total length of the glass preform relative to the glass preform away from the center of the glass preform.

From the corresponding end of the glass preform in the direction of the center of the glass preform, the plasma generator thus remains continuously longer above a particular axial position of the glass preform than would be the case with the relative feed rate V_{rück}. The plasma generator remains above a particular axial position of the glass preform relative to the glass preform for the shortest period of time when the relative feed rate has the value V_{rück}. At the same time, this has the result that a particular axial position of the glass preform that has just been passed with a value for the relative feed rate between V_{Mitte} and Vₕᵢₙ is passed in the directly consecutive pass with a higher value for the relative feed rate, namely, between V_{rück} and V_{Mitte}. A decelerated forward pass in comparison to V_{Mitte} is thus directly followed by an accelerated backward pass in comparison to V_{Mitte}.

In summary, the profile of the relative feed rate is thus as follows: The relative feed rate in the center of the glass preform has the value V_{Mitte}. During a movement of the plasma generator relative to the glass preform from the center of the glass preform in the direction of one of the reversal points, the relative feed rate is reduced from V_{Mitte} to Vₕᵢₙ until the slowest relative feed rate, preferably as value Vₕᵢₙ, is reached when the corresponding end of the glass preform is reached. At the reversal point, the direction of the relative movement changes. During the relative movement from the corresponding reversal point in the direction of the center of the glass preform, the relative feed rate takes the value V_{rück}, which is reduced again in the direction of the center of the glass preform to the value V_{Mitte}. A decelerated forward pass, in comparison to V_{Mitte}, to the edge of the glass preform is directly followed by an accelerated backward pass, in comparison to V_{Mitte}, from the same edge in the direction of the center of the glass preform.

Varying the relative feed rate can reduce the thermal stress, in particular of the edges of the glass preform, allowing more uniform deposition of the synthesized glass particles.

This leads to less production waste. In particular, the relatively fast pass from the particular edge in the direction of the center of the glass preform, which is carried out at a relative feed rate between V_{rück} and V_{Mitte}, reduces the thermal stress. As compensation, the pass in the opposite direction, i.e., from the center of the glass preform in the direction of the corresponding reversal point, is carried out at a relative feed rate between V_{Mitte} and Vₕᵢₙ, and thus in a decelerated manner in comparison to the value V_{Mitte} in the region of the center of the glass preform.

During the relative movement of the plasma generator from the center of the glass preform in the direction of the corresponding reversal point, the edges of the glass preform thus experience an increased exposure to the plasma zone in comparison to the center of the glass preform, whereas, in the opposite direction, i.e., from the reversal point in the direction of the center of the glass preform, a comparatively reduced exposure to the plasma zone takes place, in particular in the region of the edges of the glass preform. A temperature difference, T_{Diff}, which a particular axial position of the glass preform has between two passes, can thus be reduced in comparison to a pass at an always constant relative feed rate. This ensures more uniform thermal stress over the entire axial length of the glass preform, which leads to more uniform deposition of the synthesized glass particles over the axial length of the glass preform.

The method is characterized by the three different values V_{Mitte}, Vₕᵢₙ, and V_{rück} for the relative feed rate, wherein it follows from the above that the relative feed rate also takes values between these three values mentioned.

From the above, it follows that the value for V_{rück} is greater than the value of V_{Mitte}, and the value of V_{Mitte} is greater than the value of Vₕᵢₙ. The value of Vₕᵢₙ is thus between the values for V_{rück} and V_{Mitte}.

In a preferred embodiment of the method, a difference between the values of V_{Mitte} and Vₕᵢₙ substantially, i.e., within certain tolerances, in particular error tolerances, corresponds to a difference between the values of V_{rück} and V_{Mitte}. In this embodiment, the value of V_{Mitte} is exactly between the values of V_{rück} and Vₕᵢₙ. In other words, in this embodiment, the relative feed rate is reduced by the same value if the plasma generator is moved relative to the glass preform from the center of the glass preform in the direction of one of the reversal points and if the plasma generator is moved relative to the glass preform from one of the reversal points in the direction of the center of the glass preform. This can lead to a reduced temperature difference T_{Diff} of a particular axial position of the glass preform between the passes.

The rate of change of the deceleration of the relative feed rate from V_{Mitte} to Vₕᵢₙ or from V_{rück} to V_{Mitte} can be designed in different ways. For example, the rate of change can be linear, resulting in a constant change in the relative feed rate.

In a preferred embodiment of the method, the reductions in the relative feed rates from V_{Mitte} to Vₕᵢₙ and from V_{rück} to V_{Mitte} have a substantially exponential or parabolic profile. In this embodiment, the reduction of the relative feed rates has a rate of change which is increasingly increased as the closer the relative feed rate approaches the target value, i.e., Vₕᵢₙ or V_{Mitte}. In this embodiment, the change in the relative feed rate is not linear but increases progressively.

This has the result that a particular axial position of the glass preform is passed over slower the longer it has been since the last pass of the plasma generator at this position. This can at least partially compensate for the increased cooling of the corresponding position since the last pass, which can lead to more uniform thermal stress. At the same time, axial positions are passed over by the plasma generator faster the shorter it has been since the last pass of the plasma generator.

A particularly slow forward pass is thus followed by a particularly fast backward pass, which can lead to more uniform deposition of the synthesized glass particles.

In a preferred embodiment of the method, the glass particles synthesized in method step a. contain a dopant. Preferably, the synthesized glass particles comprise dopants selected from the group consisting of germanium dioxide (GeO₂), phosphorus pentoxide (P₂O₅), fluorine (F₂), boron dioxide (B₂O₃), and aluminum oxide (Al₂O₃). To introduce the dopants into the synthesized glass particles, appropriate dopant precursors, which are known to a person skilled in the art, are added to the plasma flame of the plasma torch. Examples of such dopant precursors include germanium tetrachloride (GeCl₄), phosphorus oxychloride (POCl₃), hydrogen fluoride (HF), silicon tetrafluoride (SiF₄), boron trifluoride (BF₃), sulfur hexafluoride (SF₆), oxygen-containing fluorinating agents such as perfluoroketones, perfluoroethers or hydrofluoroethers, nitrile-containing fluorinating agents such as perfluoronitriles, boron trichloride (BCl₃) and aluminum chloride (AlCl₃).

The variation according to the invention of the relative feed rate, which reduces the thermal stress, in particular of the edges of the glass preform, also has a positive effect on a uniform dopant concentration over the axial length of the glass preform. More uniform fluorine doping can be achieved, which reacts particularly sensitively to uneven thermal stresses during deposition on the glass preform.

The relative feed rates V_{Mitte}, Vₕᵢₙ, and V_{rück} can take different absolute values. The absolute values can be adjusted, for example, depending on the composition of the glass preform, the composition of the synthesized glass particles, the length of the glass preform, its outer diameter, and/or its rotation speed.

In a preferred embodiment of the method, V_{Mitte} has a value in the range between 500 mm/min and 3000 mm/min, preferably in the range between 700 mm/min and 2500 mm/min, more preferably in the range between 800 mm/min and 1500 mm/min.

The values for Vₕᵢₙ and V_{rück} are to be adapted to the value of V_{Mitte}, the composition of the glass preform, the composition of the synthesized glass particles, the length of the glass preform, its outer diameter, and/or its rotation speed in order to achieve the lowest possible thermal stress, in particular of the edges of the glass preform.

In a preferred embodiment of the method, Vₕᵢₙ has a value in the range between 0.4 times to 0.9 times, preferably in the range between 0.5 times to 0.85 times, V_{Mitte}.

In a preferred embodiment of the method, V_{rück} has a value in the range between 1.1 times and 1.6 times, preferably in the range between 1.15 times to 1.5 times, V_{Mitte}. Also, in a preferred embodiment of the method, the average dwell time of the plasma generator at each axial position of the glass preform is substantially the same, i.e., with certain tolerances. In this embodiment, Vₕᵢₙ and V_{rück} are coordinated in such a way that the plasma generator remains in total at a particular axial position of the glass preform that is passed over twice directly consecutively at a value for the relative feed rate between V_{Mitte} and Vₕᵢₙ or in the opposite direction between V_{rück} and V_{Mitte}, as long as would be the case if it were passed over twice at the rate V_{Mitte}. In other words, each axial position of the glass preform is thus exposed to the plasma zone generated by the plasma generator for the same length of time during two directly consecutive passes. This leads to more uniform deposition of the synthesized glass particles, in particular at the edges of the glass preform.

The relative feed rate can have the value V_{Mitte} over axial sections of the glass preform of different lengths. For example, the relative feed rate takes the value V_{Mitte} only exactly in the center of the glass preform, whereas the relative feed rate has a value between V_{rück} and V_{Mitte} directly in front of the center of the glass preform in the passing direction and the relative feed rate has a value between V_{Mitte} and Vₕᵢₙ directly after the center of the glass preform in the passing direction. In this embodiment, the relative feed rate has the value V_{Mitte} substantially at a point-like axial position, namely, the center, of the glass preform.

In a preferred embodiment of the method, the relative feed rate takes the value V_{Mitte} over an axial extent of the glass preform which corresponds to 0% to 50%, preferably 15% to 45%, more preferably 20% to 40%, of a total axial length of the glass preform. This axial extent in any case comprises the center of the glass preform, wherein the center of the glass preform is preferably also the axial center of the axial extent.

In addition to varying the relative feed rate, further process parameters can also be varied, in particular depending on the axial position of the glass preform, in order to make the thermal stress, in particular of the edges of the glass preform, as uniform as possible.

For example, the rotational movement, in the form of the rotation speed, of the glass preform about its longitudinal axis can be varied.

A further possible variation relates to the plasma generator in the form of a plasma torch. For example, its distance from the glass preform, preferably in the form of a glass rod, can be varied in order to allow the most uniform possible deposition of the synthesized glass particles.

A preferred embodiment of the method comprises:
(i) a plasma power in the center of the glass preform has a value of P_{Mitte};
(ii) wherein the plasma power is increased from P_{Mitte} to a value of Pₕᵢₙ if the plasma generator moves relatively from the center of the glass preform toward one of the reversal points; and,
(iii) the plasma power is increased from a value P_{rück} to P_{Mitte} if the plasma generator moves relatively from one of the reversal points toward the center of the glass preform.

In this embodiment, the plasma power is thus increased as the relative feed rate decreases in comparison to V_{Mitte} or reduced as the relative feed rate increases in comparison to V_{Mitte}.

The temperature of the glass preform at a particular axial position varies in the course of the method and depends in particular on the time point of the last pass of the plasma generator at the corresponding axial position, on the plasma power prevailing at that time, the dwell time of the plasma generator at the corresponding axial position during this pass and, in particular in the case of a plasma generator in the form of a plasma torch, on its distance from the glass preform, preferably in the form of a glass rod.

In a preferred embodiment of the method, the glass preform in the course of the method has a temperature between a minimum temperature T_{Min} and a maximum temperature T_{Max}, wherein the temperature difference T_{Diff} between T_{Min} and T_{Max} is at most 200 K, preferably at most 190 K, more preferably at most 180 K.

In a preferred embodiment of the method, T_{Max} at most takes a value of 2650° C.

The temperature measurements were carried out optically with a thermal camera (model DIAS PyroView 640G from DIAS Infrared GmbH, Germany) in a spectral range of 4.8 μm to 5.2 μm. How to carry out such a measurement and its required parameters are known to a person skilled in the art.

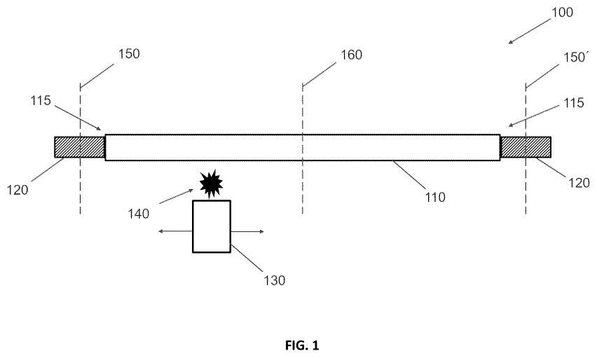

FIG. 1 shows a schematic exemplary arrangement 100 of a method for producing an optical fiber preform. The arrangement comprises a glass preform 110 in the form of a glass rod consisting of a quartz glass, wherein the glass preform 110 is clamped at its axial edges 115 between two glass sleeves 120 in order to secure it. The arrangement 100 furthermore comprises a plasma generator 130 in the form of a plasma torch. During the method, the plasma generator 130 serves to synthesize, optionally doped, glass particles in a plasma zone 140 in the form of a plasma flame of the plasma torch. For this purpose, glass precursors and optionally dopants as well as oxygen and any auxiliary gases are constantly fed to the plasma generator 130, to the plasma zone 140 in the form of a plasma flame, during the method. These glass particles synthesized in this way are deposited onto the glass preform 110 by expansion of the plasma flame while the glass preform 110 undergoes a rotational movement about its longitudinal axis and the plasma generator 130 and the glass preform 110 move relative to each other in an axial forward and backward movement. During this relative movement, the glass preform 110, the plasma generator 130, or the glass preform 110 and the plasma generator 130 can be moved. In the embodiment shown, the plasma generator 130 moves (indicated by the two opposite arrows on the plasma generator 130). The relative movement between the plasma generator 130 and the glass preform 110 takes place between two reversal points 150, 150′. In the embodiment of the method shown, this means that the plasma generator 130 is repeatedly moved from one reversal point 150, 150′ to the opposite reversal point 150, 150′ while the glass preform 110 rotates about its own longitudinal axis. This allows the glass particles synthesized in the plasma zone 140 to be deposited over the entire surface of the glass preform 110. In the embodiment shown, the reversal points 150, 150′ are located at the axial height of the sleeves 120 and thus lie outside the axial extent of the glass preform 110. Since the relative movement changes direction at the reversal points 150, 150′, i.e., a forward movement becomes a backward movement, or vice versa, it can happen that the reversal points 150, 150′ are exposed to the plasma zone 140 for a relatively long period of time. If the reversal points 150, 150′ were arranged at the axial height of the glass preform 110, this could lead to high thermal stress at the corresponding positions of the glass preform 110, which is why it is preferred not to arrange the reversal points 150, 150′ at the axial height of the glass preform 110. The reversal points 150, 150′ are furthermore equidistant from a center 160, in particular axial center 160, of the glass preform 110, which can facilitate uniform deposition of the synthesized glass particles over the entire length of the glass preform 110.

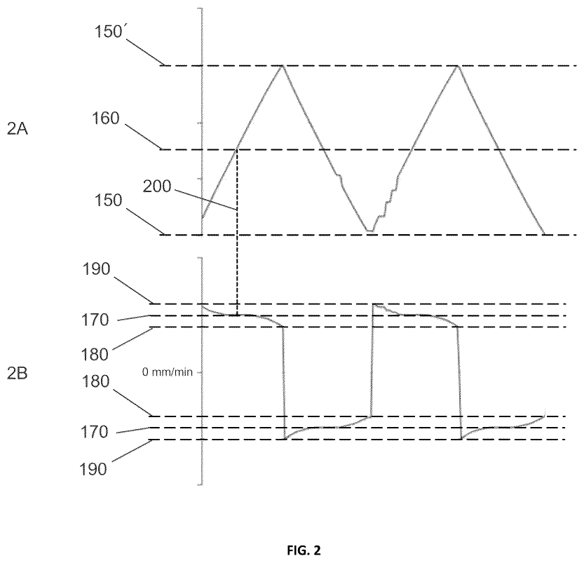

For a description of the relative movement of the glass preform 110 and the plasma generator 140, in particular, the variation of the relative feed rate, reference is made to FIG. 2.

FIG. 2 shows a variation of the relative feed rates of the relative movement of the plasma generator 130 and the glass preform 110 using the arrangement 100 of FIG. 1. The relative feed rate is adapted to the axial position taken by the plasma generator 130 (see FIG. 1) relative to the glass preform 110. The illustration 2A shows the axial position of the glass preform 110, which is passed over by the plasma generator 130 at a given time point in the method. It can be seen that, during a pass, the plasma generator 130 is moved, at least relatively speaking, from one of the reversal points 150, 150′ (see FIG. 1) via the center 160 (see FIG. 1) of the glass preform 110 to the axially opposite reversal point 150, 150 ′wherein, when the reversal point 150, 150′ is reached, a reversal of movement takes place in the direction of the other reversal point 150, 150′.

The illustration 2B shows the values for the relative feed rate of the plasma generator 130 to the glass preform 110 depending on the axial position of FIG. 2A. If the plasma generator 130 is located at the position of the center 160 of the glass preform 110 (marked by the dashed line 200), the relative feed rate takes the value V_{Mitte} 170. If the plasma generator 130 moves from the center 160 of the glass preform 110 in the direction of the reversal point 150′ (following the illustrations from the dashed line 200 to the right), the relative feed rate is reduced from the value V_{Mitte} 170 to the value Vₕᵢₙ 180, which is taken when the reversal point 150′ is reached. In the embodiment shown, Vₕᵢₙ corresponds to 0.8 times V_{Mitte}. At the reversal point 150′a reversal of movement takes place. The reversal of movement leads the plasma generator 130 from the reversal point 150′ via the center 160 of the glass preform 110 to the axially opposite reversal point 150 (following the illustrations further to the right). This reverse relative movement starts with a relative feed rate that takes a value V_{rück} 190, which is shown with a negative value at this time point in the method to illustrate the direction of movement. During the relative movement of the plasma generator 130 from the reversal point 150′ in the direction of the center 160 of the glass preform 110, the relative feed rate is reduced again from V_{rück} to V_{Mitte}. In the embodiment shown, V_{rück} corresponds to 1.2 times V_{Mitte}. This sequence of the relative movement is repeated, each time with alternating directions of the relative movement, until the desired deposition of the synthesized glass particles on the glass preform 110 is achieved.

Illustration 2B shows that the reduction of the relative feed rate in the embodiment shown has an exponential profile.

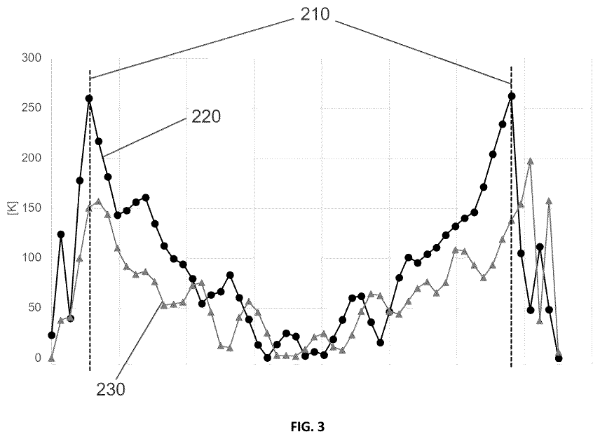

FIG. 3 shows a temperature difference T_{Diff} as a result of the above-described variation of the relative feed rate of FIG. 2 (Graph 220) in Kelvin. The temperature difference T_{Diff} results from a maximum temperature T_{Max} and a minimum temperature T_{Min} which the glass preform 110 in the form of a glass rod has in the course of the method sequence. For comparison, a temperature difference of a comparison glass rod (Graph 230) is shown, wherein the comparison glass rod was passed over not at a varied relative feed rate, but at a relative feed rate with a constant value, in this case constant with the value V_{Mitte}. Otherwise, the materials and method conditions were identical. The temperature differences (plotted on the y-axis) were plotted versus the corresponding axial position of the measurement (plotted on the x-axis). For better clarity, the ends of the glass rods 110 were marked with the dashed lines 210.

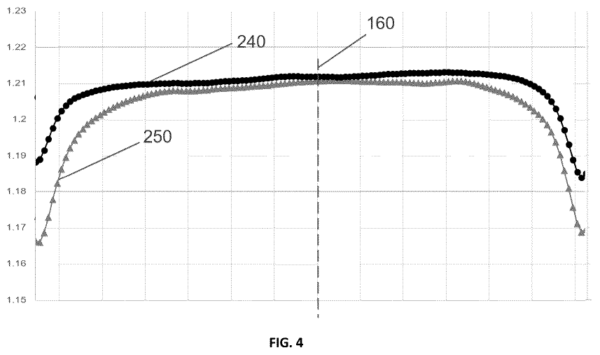

FIG. 3 shows that the variable relative feed rate according to the invention, which is varied between the values V_{Mitte}, Vₕᵢₙ, and V_{rück} depending on the axial position of the plasma generator 140 and the glass preform 110, leads to more uniform thermal stress (smaller temperature differences, in particular, in the region of the edges 115 of the glass preform 110). This leads to more uniform deposition of the synthesized glass particles on the glass preform 110 so that less production waste is generated (see also FIG. 4).

FIG. 4 shows a deposition profile 240 of a preform, produced by means of the method according to the invention, of FIG. 2 and the temperature difference T_{Diff}, prevailing therein, of FIG. 3 (see Graph 220) in comparison to a comparison deposition profile 250 of a comparison preform produced by means of the method with the comparison glass rod at a constant relative feed rate and the corresponding temperature difference of FIG. 3 (see Graph 230). In each case, the ratio of the outer diameter of the starting glass rod to the outer diameter of the final preform (y-axis) is plotted versus the axial position (x-axis) over the entire length of the preform. In the center 160 of the preform, which is in each case passed over at the relative feed rate with the value V_{Mitte}, comparable deposits can be found in each case. However, significant differences can be found at the two edges of the preforms: While the comparison preform shows significantly fewer deposits at the edges, the edges of the preform produced according to the invention are significantly raised in comparison, which leads to less production waste.

### REFERENCE SIGNS

100 Arrangement
110 Glass preform
120 Glass sleeve
130 Plasma generator
140 Plasma zone
150, 150′ Reversal point
160 Center of the glass preform
170 V^{Mitte}
180 V^{hin}
190 V^{rück}
200 Dashed line
210 Ends of the glass preform
220 Temperature difference with variable relative feed rate
230 Temperature difference with constant relative feed rate
240 Deposition profile with variable relative feed rate
250 Deposition profile with constant relative feed rate

1. A method for producing an optical fiber preform, comprising the method steps of:
a. synthesizing glass particles using a plasma zone generated by a plasma generator;
b. repeatedly moving a glass preform axially forward and backward relative to the plasma generator during a rotational movement of the glass preform, wherein the forward and backward movement takes place between two reversal points at a relative feed rate; and,
c. depositing the glass particles on the glass preform while the glass preform moves and rotates relative to the plasma generator; wherein
(i) the relative feed rate of the plasma generator with respect to the glass preform has a value of V_{Mitte} at a center of the glass preform;
(ii) the relative feed rate of the plasma generator with respect to the glass preform is reduced from V_{Mitte} to a value of Vₕᵢₙ if the plasma generator moves relatively from the center of the glass preform toward one of the reversal points; and,
(iii) the relative feed rate of the plasma generator with respect to the glass preform is reduced from a value of V_{rück} to V_{Mitte} if the plasma generator moves relatively from one of the reversal points toward the center of the glass preform.

2. The method according to claim 1, wherein V_{rück}>V_{Mitte}>V_{hin.}

3. The method according to claim 1, wherein the difference in values between V_{Mitte} and Vₕᵢₙ substantially corresponds to the difference in values between V_{rück} and V_{Mitte}.

4. The method according to claim 1, wherein the reductions in relative feed rates from V_{Mitte} to Vₕᵢₙ and from V_{rück} to V_{Mitte} comprise a substantially exponential or parabolic profile.

5. The method according to claim 1, wherein the glass particles synthesized in method step a. contain a dopant.

6. The method according to claim 1, wherein V_{Mitte} has a value in the range between 500 mm/min and 3000 mm/min.

7. The method according to claim 1, wherein Vₕᵢₙ has a value in the range between 0.4 times and 0.9 times V_{Mitte}.

8. The method according to claim 1, wherein V_{rück} has a value in the range between 1.1 times and 1.6 times V_{Mitte}.

9. The method according to claim 1, wherein the average dwell time of the plasma generator at each axial position of the glass preform is substantially the same.

10. The method according to claim 1, wherein the relative feed rate takes the value V_{Mitte} over an axial extent of the glass preform corresponding to 0-50% of the total axial length of the glass preform.

11. The method according to claim 1, wherein
(i) a plasma power in the center of the glass preform has a value of P_{Mitte};
(ii) the plasma power is increased from P_{Mitte} to a value of Pₕᵢₙ if the plasma generator moves relatively from the center of the glass preform toward one of the reversal points; and,
(iii) the plasma power is increased from a value P_{rück} to P_{Mitte} if the plasma generator moves relatively from one of the reversal points toward the center of the glass preform.

12. The method according to claim 11, wherein the plasma power is increased if the relative feed rate is reduced.

13. The method according claim 1, wherein the glass preform in the course of the method has a temperature between a minimum temperature T_{Min} and a maximum temperature T_{Max}, wherein the temperature difference T_{Diff} between T_{Min} and T_{Max} is at most 200 K.

14. The method according to claim 13, wherein T_{Max} assumes a maximum value of 2650° C.

15. The method according to claim 1, wherein the glass preform is a glass rod, the plasma generator is a plasma torch and the plasma zone is a plasma flame.

16. The method according to claim 2, wherein the difference in values between V_{Mitte} and Vₕᵢₙ substantially corresponds to the difference in values between V_{rück} and V_{Mitte}.

17. The method according to claim 2, wherein the reductions in relative feed rates from V_{Mitte} to Vₕᵢₙ and from V_{rück} to V_{Mitte} comprise a substantially exponential or parabolic profile.

18. The method according to claim 3, wherein the reductions in relative feed rates from V_{Mitte} to Vₕᵢₙ and from V_{rück} to V_{Mitte} comprise a substantially exponential or parabolic profile.

19. The method according to claim 2, wherein the glass particles synthesized in method step a. contain a dopant.

20. The method according to claim 3, wherein the glass particles synthesized in method step a. contain a dopant.
